(19) United States
(12) Patent Application Publication
(10) Pub. No.: US 2008/0057248 A1
(43) Pub. Date: Mar. 6, 2008

(54) Multilayer hose for fuel, chemical and vapor transport

(75) Inventors: Richard Wayne Hatchett, Huntingdon, TN (US); John Mobley, Lexington, TN (US); Jerry Shifman, Wildersville, TN (US); Jeremy W. Duke, Lexington, TN (US)

Correspondence Address: DAYCO PRODUCTS, LLC, 1 PRESTIGE PLACE, MIAMISBURG, OH, 45342, US

(73) Assignee: Dayco Products, LLC

(21) Appl. No.: 11/513,371

(22) Filed: Aug. 30, 2006

(51) Int. Cl. B32B 27/36; B32B 1/08; B32B 27/30; B32B 27/32

(52) U.S. Cl. 428/36.91; 428/421; 428/522; 428/523; 428/480

(57) ABSTRACT

A tubular structure having reduced fuel permeation for use in fuel filler and fuel vent hose application, wherein the tubular structure comprises a nitrile or a chlorinated polyethylene inner layer, a tetrafluoroethylene-hexafluoropropylene-vinylidene fluoride terpolymer barrier layer on the nitrile or chlorinated polyethylene inner layer, and a chlorinated polyethylene outer cover layer, and a method of forming such tubular structures are described. The tubular structure optionally includes a chlorinated polyethylene backing layer, one or more polyamide adhesive layers, and a reinforcement layer.

### BACKGROUND OF THE INVENTION

The present invention relates to the field of multilayer hoses, and particularly to the field of flexible polymeric hoses for use in fuel, chemical and vapor transport.

Flexible polymeric hoses are generally used in a variety of uses such as automobile fuel feed hoses, fuel vent hoses, torque converter hoses, power steering hoses, air conditioner hoses, brake fluid hoses, industrial hydraulic hoses and compressed gas hoses, refrigerator hoses, garden hoses, propane gas hoses, etc. Various types of tubing construction have been employed to meet the needs of the various applications of hoses. For example, multilayer tubular structures are commonly used in the automotive industry as fuel and chemical transport hoses and fuel vent hoses. Choosing the right combination of materials used in the construction of such hoses is becoming more difficult due to environmental regulations, which severely limit the amount of fuel vapor that can permeate from the fuel system of a motor vehicle. Typically, fuel filler and vent hoses are multi layer tubular structures constructed of a natural or synthetic rubber material such as a conductive nitrile, e.g., acrylonitrile rubber, a fluoropolymer barrier layer such as a tetrafluoroethylene-hexafluoropropylene-vinylidene fluoride terpolymer (THV) barrier layer, a nitrile backing layer, a reinforcement layer and 8 chlorinated polyethylene (CPE) cover layer.

The overall cost and effectiveness of such hoses has proven to be somewhat disappointing. Therefore, there is a need for a fuel and chemical transport hose as well as a fuel vent hose which is more economical to produce and which exhibits improved properties.

### SUMMARY OF THE INVENTION

According to the present invention there is provided an improved multilayer tubular structure which is less costly to manufacture than prior multilayer fuel transport hoses and, in some cases, like fuel-alcohol blends, the fuel resistance of chlorinated polyethylene backing layer or cover layer is superior to the nitrile currently used as a backing layer. In addition to reduced permeability, the hose has adequate strength and durability over long periods of time, and is resistant to chemical degradation by the fluids being transported therein.

Since it is well known in the industry that hoses used to transport fuels are required to contain a conductive agent or otherwise exhibit conductive characteristics in order to dissipate any electrical buildup which may occur during the flow of fuel through the hose, the hose of the hose of the present application contains therein such a conductive agent.

In a first embodiment, the fuel and chemical transport hose of the present invention comprises: a conductive nitrile inner layer, a tetrafluoroethylene-hexafluoropropylene-vinylidene fluoride terpolymer (THV) barrier layer, an adhesive layer, a chlorinated polyethylene (CPE) backing layer, a reinforcement layer, and a chlorinated polyethylene cover layer.

In a second embodiment, the fuel and chemical transport hose of the present Invention comprises: a conductive nitrile inner layer, a tetrafluoroethylene-hexafluoropropylene-vinylidene fluoride terpolymer barrier layer, a reinforcement layer and a chlorinated polyethylene cover layer.

In a third embodiment, the fuel and chemical transport layer of the present invention comprises: a conductive chlorinated polyethylene inner layer, an adhesive layer, a tetrafluoroethylene-hexafluoropropylene-vinylidene fluoride terpolymer barrier layer, an adhesive layer, a chlorinated, polyethylene backing layer, a reinforcement layer, and a chlorinated polyethylene cover layer.

In a fourth embodiment, the fuel and chemical transport hose of the present invention comprises: a conductive chlorinated polyethylene inner layer, an adhesive layer, a tetrafluoroethylene-hexafluoropropylene-vinylidene fluoride terpolymer barrier layer, a reinforcement layer, and a chlorinated polyethylene cover layer.

In a fifth embodiment, the fuel and chemical transport hose of the present invention comprises: a conductive nitrile inner layer, a tetrafluoroethylene-hexafluoropropylene-vinylidene fluoride terpolymer barrier layer, an adhesive layer, and a chlorinated polyethylene cover layer.

In a sixth embodiment, the fuel and chemical transport hose of the present invention comprises: a conductive chlorinated polyethylene inner layer, an adhesive layer, a tetrafluoroethytene-hexafluoropropylene-vinylidene fluoride terpolymer barrier layer, an adhesive layer, and a chlorinated polyethylene cover layer.

In those instances where the tetrafluoroethylene-hexafluoropropylene-vinylidene fluoride (THV) is adjacent the chlorinated polyethylene layer, a polyamine adhesive is preferably used to adhere the CPE layer to the THV layer.

Typically, the hoses of the present invention are useful as automobile fuel vent hoses, fuel filler hose, vapor lines and fuel feed lines.

### BRIEF DESCRIPTION OF THE DRAWINGS

FIG. 1 is a perspective view illustrating a first embodiment of the invention;

FIG. 2 is a perspective view illustrating a second embodiment of the invention;

FIG. 3 is a perspective view illustrating a third embodiment of the invention;

FIG. 4 is a perspective view illustrating a fourth embodiment of the invention;

FIG. 5 is a perspective view illustrating a fifth embodiment of the invention; and

FIG. 6 is a perspective view illustrating a sixth embodiment of the invention.

### DETAILED DESCRIPTION OF THE INVENTION

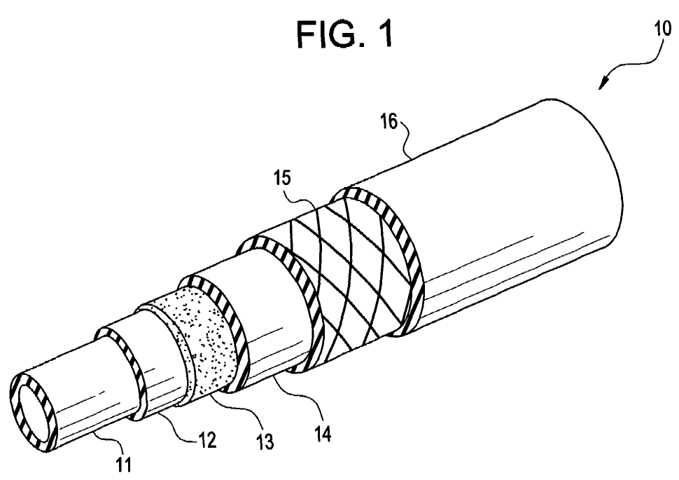

With respect to the drawings, FIG. 1 is a tubular structure in accordance with a first embodiment of the invention where a tubular structure 10 is made from a nitrile polymeric material 11, a tetrafluoroethylene-hexafluoropropylene-vinylidene fluoride terpolymer barrier layer 12 surrounding the outer surface of the nitrile layer 11, an adhesive layer 13 on the surface of the tetrafluoroethylene-hexafluoropropylene-vinylidene fluoride terpolymer barrier layer 12, a chlorinated polyethylene layer 14 on top of the adhesive layer 13, a reinforcement layer 15 surrounding the chlorinated polyethylene layer 18, and a chlorinated polyethylene cover 16 surrounding the reinforcement layer and forming the outside layer of the tubular structure 10.

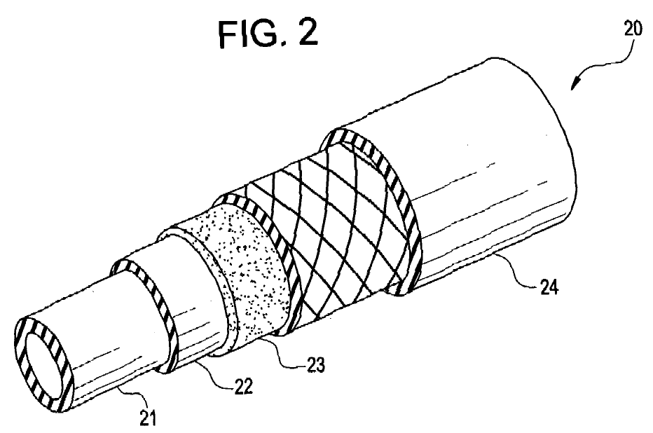

FIG. 2 is a tubular structure In accordance with a second embodiment of the invention where a tubular structure 20 is made from a nitrile polymeric material 21, a tetrafluoroethylene-hexafluoropropylene-vinylidene fluoride terpolymer barrier layer 22 surrounding the outer surface of the nitrile layer 21, a reinforcement layer 23 surrounding the tetrafluoroethylene-hexafluoropropylene-vinylidene fluoride terpolymer barrier layer 22, and a chlorinated polyethylene cover 24 surrounding the reinforcement layer and forming the outside layer of the tubular structure 20.

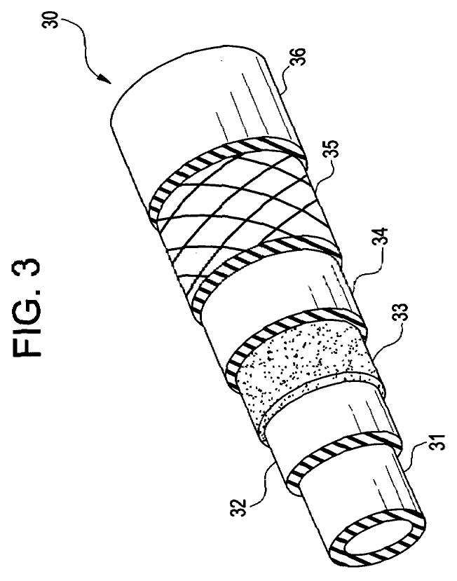

FIG. 3 is a tubular structure in accordance with a third embodiment of the invention where a tubular structure 30 is made from a chlorinated polyethylene material 31, a first adhesive layer 32 on the outer surface of the chlorinated polyethylene material 31, a tetrafluoroethylene-hexafluoropropylene-vinylidene fluoride terpolymer barrier layer 33 on top of the first adhesive layer 32, a second adhesive layer 34 on the outer surface of the a tetrafluoroethylene-hexafluoropropylene-vinylidene fluoride terpolymer barrier layer 33, a chlorinated polyethylene backing layer 35 surrounding the outer surface of the second adhesive layer 34, a reinforcement layer 36 surrounding the chlorinated polyethylene backing layer 35, and a chlorinated polyethylene cover 37 surrounding the reinforcement layer 38 and forming the outside layer of the tubular structure 30.

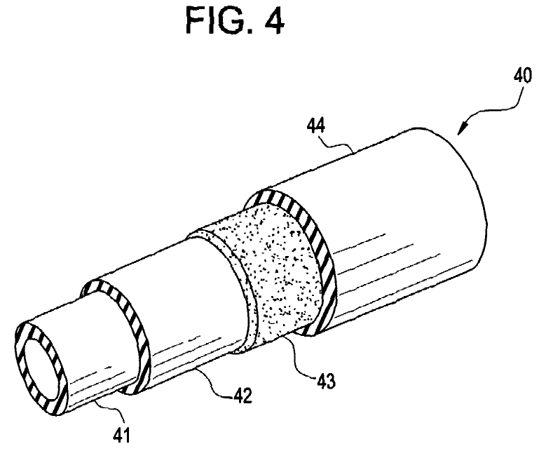

FIG. 4 is a tubular structure in accordance with a fourth embodiment of the invention where a tubular structure 40 is made from a chlorinated polyethylene material 41, a first adhesive layer 42 surrounding the outer surface of the chlorinated polyethylene inner layer 41, a tetrafluoroethylene-hexafluoropropylene-vinylidene fluoride terpolymer barrier layer 43 surrounding the first adhesive material layer 42, a second adhesive layer 44 on top of the tetrafluoroethylene-hexafluoropropylene-vinylidene fluoride terpolymer barrier layer 43, a chlorinated polyethylene cover 45 surrounding the second adhesive layer 44 and forming the outside layer of the tubular structure 40.

FIG. 5 is a tubular structure in accordance with a fifth embodiment of the invention where a tubular structure 50 is made from a nitrile polymeric material 61, a tetrafluoroethylene-hexafluoropropylene-vinylidene fluoride terpolymer barrier layer 52 surrounding the outer surface of the nitrile material 51, an adhesive layer 53 surrounding the tetrafluoroethylene-hexafluoropropylene-vinylidene fluoride terpolymer barrier layer 52, and a chlorinated polyethylene cover 64 surrounding the adhesive layer 53 and forming the outside layer of the tubular structure 50.

FIG. 6 is a tubular structure in accordance with a sixth embodiment of the invention where a tubular structure 60 is made from a chlorinated polyethylene material 61, a tetrafluoroethylene-hexafluoropropylene-vinylidene fluoride terpolymer barrier layer 62 surrounding the outer surface of the chlorinated polyethylene layer 61, an adhesive layer 63 surrounding the tetrafluoroethytene-hexafluoropropylene-vinylidene fluoride terpolymer barrier layer 62, and a chlorinated polyethylene cover 64 surrounding the adhesive layer 53 and forming the outside layer of the tubular structure 60.

Typically, the inner layer of the tubular structure is a nitrile material such as acrylonitrile-butadiene polymer. It has been found that, in certain application such as in the manufacture of a fuel filler hose or vapor hose, chlorinated polyethylene may provide an improved alternative to the nitrile as the inner layer of the tubular structure.

The barrier layer of the tubular structure is a fluoropolymer which prevents or reduces the permeation of fuel, chemical and vapor through the barrier layer. Preferably, the barrier layer is a fluoropolymer containing polymerized units of tetrafluoroethylene, hexafluoropropylene and vinylidene fluoride. Preferably, the fluoropolymer is a tetrafluoroethylene-hexafluoropropylene-vinylidene fluoride terpolymer having a fluorine content of about 67 to 73% by weight.

The reinforcement materials useful in the present invention include natural and synthetic fibers such rayon, polyesters, aramid material, polyamides, e.g., nylon, polyimids, and any other suitable materials.

Typically, the inner layer of the tubular structure contains a conductive material such as metal or carbon. Preferably, the conductive material is carbon in the form of carbon black, but may be any conductive agent or combination of conducting agents commonly recognized in the industry to provide conductivity to a rubber or plastic material. Examples of such conductive agents include elemental carbon in the form of carbon black and carbon fibrils, metals such as copper, silver, gold, nickel, and alloys or mixtures of such metals. The use of such conductive agents is known in the art to dissipate static electricity in the transportation of a fluid through the tubular structure.

It is generally preferred to include an adhesive material between the chlorinated polyethylene layers and the tetrafluoroethylene-hexafluoropropylene-vinylidene fluoride terpolymer layers in order to prevent or reduce the likelihood of the two layers separating during use.

Non-conducting polymer materials also may be employed as the inner layer in applications where dissipation of static electricity is not required.

Other additives such as antioxidants, processing aids, etc. may be employed in amounts and methods known in the art.

The tubular structures of the present invention are formed by extruding the various layers using simultaneous or tandem extrusion.

Having described the invention in detail and by reference to preferred embodiments thereof, it will be apparent to those skilled in the art that modifications and variations are possible without departing from the scope of the invention defined in the appended claims.

What is claimed is:

1. A tubular structure having reduced fuel permeation for use as fuel filler and fuel vent hose applications, wherein said structure comprises a nitrile or a chlorinated polyethylene inner layer, a tetrafluoroethylene-hexafluoropropylene-vinylidene fluoride terpolymer barrier layer on said nitrile or chlorinated polyethylene inner layer, and a chlorinated polyethylene cover layer.

2. The tubular structure of claim 1, further comprising a reinforcement layer between said tetrafluoroethylene-hexafluoropropylene-vinylidene fluoride terpolymer barrier layer and said chlorinated polyethylene cover layer.

3. The tubular structure of claim 2 further comprising a chlorinated polyethylene backing layer between said tetrafluoroethylene-hexafluoropropylene-vinylidene fluoride terpolymer barrier layer and said reinforcement layer.

4. The tubular structure of claim 1 further comprising an adhesive layer between said tetrafluoroethylene-hexafluoropropylene-vinylidene fluoride terpolymer barrier layer and said chlorinated polyethylene cover layer.

5. The tubular structure of claim 4 wherein said adhesive layer is a polyamine layer.

6. The tubular structure of claim 3 further comprising an adhesive layer between said tetrafluoroethylene-hexafluoropropylene vinylidene fluoride barrier layer and said chlorinated polyethylene backing layer.

7. The tubular structure of claim 6, wherein said adhesive layer is a polyamine layer.

8. The tubular structure of claim 1, wherein said nitrile or said chlorinated polyethylene inner layer includes a conductive material selected from the group consisting of carbon, iron, gold, silver, nickel, copper, and alloys and mixtures thereof.

9. The tubular structure of claim 8, wherein said conductive material is carbon.

10. The tubular structure of claim 9, wherein said carbon conductive material is in the form of carbon powder or carbon fibrils.

11. The tubular structure of claim 1, wherein said tubular structure is corrugated thereby providing improved flexibility to said tubular structure.

12. The tubular structure of claim 2 wherein said reinforcement layer is a natural or synthetic fiber material selected from the group consisting of polyamide, polyamide, polyester and cotton.

13. The tubular structure of claim 1, wherein said tubular structure comprises a conductive nitrile inner layer, a tetrafluoroethylene-hexafluoropropylene-vinylidene fluoride terpolymer barrier layer, a polyester reinforcement layer, and a chlorinated polyethylene cover layer.

14. The tubular structure of claim 13 wherein said conductive nitrile inner layer contains carbon in the form of carbon fibrils as a conductive agent.

15. The tubular structure of claim 1, wherein said tubular structure comprises a conductive nitrile inner layer, a tetrafluoroethylene-hexafluoropropylene-vinylidene fluoride terpolymer barrier layer, a polyamine adhesive layer, a chlorinated, polyethylene backing layer, a polyester reinforcement layer, and a chlorinated polyethylene cover layer.

16. The tubular structure of claim 15, wherein said conductive nitrile inner layer contains carbon in the form of carbon powder or carbon fibrils as at conductive agent.

17. The tubular structure of claim 1, wherein said tubular structure comprises a conductive chlorinated polyethylene inner layer, a tetrafluoroethylene-hexafluoropropylene-vinylidene fluoride terpolymer barrier layer, a polyamine adhesive layer, a chlorinated polyethylene backing layer, a polyester reinforcement layer, and a chlorinated polyethylene cover layer.

18. The tubular structure of claim 17, wherein said conductive chlorinated polyethylene inner layer contains carbon in the form of carbon powder or carbon fibrils as a conductive agent.

19. A tubular structure having reduced fuel permeation for use in fuel filler and fuel vent hose applications, said tubular structure comprising a conductive nitrile inner layer, a tetrafluoroethylene-hexafluoropropylene-vinylidene terpolymer barrier layer, a polyamine adhesive layer, a chlorinated polyethylene backing layer, a polyester reinforcement layer, and a chlorinated polyethylene cover layer.

20. A tubular structure having reduced fuel permeation for use in fuel filler and fuel vent hose applications, said tubular structure comprising a conductive chlorinated polyethylene inner layer, a tetrafluoroethylene-hexafluoropropylene-vinylidene fluoride terpolymer barrier layer, a polyamine adhesive layer chlorinated polyethylene backing layer, a polyester reinforcement layer, and a chlorinated polyethylene cover layer.

21. A method of manufacturing a tubular structure, said method comprising: forming a first layer of a nitrile or a chlorinated polyethylene; forming a tetrafluoroethylene-hexafluoropropylene-vinylidene fluoride terpolymer barrier layer around said first nitrile or chlorinated polyethylene inner layer; and forming a cover layer around said tetrafluoroethylene-hexafluoropropylene-vinylidene fluoride terpolymer barrier layer.

22. The method of claim 21, wherein said first layer is a nitrile layer.

23. The method of claim 21, wherein said first layer is a chlorinated polyethylene.

24. The method of claim 21, wherein said cover layer is a chlorinated polyethylene layer.

25. The method of claim 21 further comprising a chlorinated, polyethylene backing layer between said inner layer and said barrier layer.

26. The method of claim 21 further comprising a reinforcement layer around said backing layer.

27. The method of claim 26 further comprising an adhesive layer between at least one of said chlorinated polyethylene backing layer and said reinforcement layer.

28. The method of claim 27, wherein said adhesive layer is a polyamine adhesive layer.

29. The method of claim 28, wherein said polyamine adhesive layer is a polyallylamine adhesive layer.

30. The method of claim 21, wherein said nitrile or said chlorinated polyethylene inner layer further includes a conductive agent selected from the group consisting of carbon, iron, gold, silver, nickel, copper, and alloys or mixtures thereof.

31. The method of claim 30, wherein said conductive agent is carbon.

32. The method of claim 31, wherein said carbon is in the form of carbon powder or carbon fibrils.
